(19) United States
(12) Patent Application Publication
(10) Pub. No.: US 2023/0168974 A1
(43) Pub. Date: Jun. 1, 2023

(54) INFORMATION PROCESSING SYSTEM, INFORMATION PROCESSING METHOD, AND STORAGE MEDIUM

(71) Applicant: Hitachi, Ltd., Tokyo (JP)

(72) Inventor: Hoshun Terazumi, Tokyo (JP)

(21) Appl. No.: 17/691,845

(22) Filed: Mar. 10, 2022

(30) Foreign Application Priority Data
Nov. 26, 2021 (JP) 2021-191766

(51) Int. Cl. G06F 11/14; G06F 16/182; H04L 67/02; H04L 67/1097; H04L 9/32

(52) U.S. Cl. CPC G06F 11/1469; G06F 11/1464; G06F 16/1827; H04L 67/02; H04L 67/1097; H04L 9/3239

(57) ABSTRACT

When an information processing system downloads a group of objects used to restore data from an object storage to an information processing apparatus, the information processing system downloads each of the group of objects to the information processing apparatus through a communication network while subjecting each object to identity verification, stores information to specify the object regarding the object that fails in the identity verification, and re-executes download targeting at the object failed in the identity verification to the information processing apparatus while subjecting the object to the identity verification. The identity verification is executed with an identity verification function of a protocol such as HTTPS used for communication through the communication network.

### CROSS-REFERENCE TO RELATED APPLICATION

This application claims priority pursuant to Japanese patent application No. 2021-191766, filed on Nov. 26, 2021, the entire disclosure of which is incorporated herein by reference.

### BACKGROUND

### Technical Field

The present disclosure relates to an information processing system, an information processing method, and a storage medium.

### Related Art

An object storage that manages data on the object basis is one of storage services provided by a cloud system. The object storage has characteristics that the object storage is excellent in scalability, that each object is stored in a bucket (a container) being a flat storage space, that the object is provided with a unique ID (uniform resource identifier or URI) and is identified by using the ID, that an access to the object is carried out by using a stateless protocol (hypertext transfer protocol secure or HTTPS) such as representational state transfer (REST), that the object storage is suitable for management of a large amount of data with a relatively less update frequency, and so forth.

“AWS CLI S3 FAQ”, [online], Amazon Web Services, Inc. or its affiliates, [date of search: Nov. 15, 2021], Internet <URL:

https://docs.aws.amazon.com/cli/latest/topic/s3-faq.html>. (Non-patent Document 1) discloses processing concerning identity verification (consistency verification) to be carried out when an object is restored (downloaded) from an object storage provided by a cloud service.

FIG. 12 shows an example of processing that uses a scheme disclosed in Non-patent Document 1. FIG. 12 shows an example of restoring an object in a network attached storage (NAS) apparatus 100 that exists in a client site through a communication network such as the Internet.

In this example, when the NAS apparatus 100 accepts a restoration instruction from a user through a user interface such as a command line interface (CLI) in the first place, the NAS apparatus 100 sends to an object storage 200 a download request for an object 220 (including body data and metadata) (S1111). In response to the download request, the object storage 200 transmits the corresponding object 220 (for download) to the NAS apparatus 100 (S1112).

The NAS apparatus 100 calculates a hash value (such as MD5) regarding the downloaded object 220 (S1113), and carries out identity verification (also referred to as “damage check”, “falsification check”, “consistency verification”, and the like) by comparing the calculated hash value with a hash value provided to the downloaded object 220 (such as a hash value calculated on the object storage 200 side and provided to a response header of HTTPS communication) (S1114). As a result of verification, when it is confirmed that the two hash values match each other (S1115), the processing concerning the accepted restoration instruction ends. On the other hand, when the two hash values do not match each other (when the download of the object ends in failure) (S1116), the NAS apparatus 100 deletes the downloaded object (S1117) and re-executes (retries) the same processing as the processing described above (S1112 to S1117) (S1118).

The above-described restoration processing requires a large load on the processing to calculate the hash value (S1113), which is carried out by the NAS apparatus 100. This processing has a problem of prolongation of processing time due to a large amount of consumption of resources particularly when the data to be restored has a large size or when the number of objects required for the restoration is large. Meanwhile, the hash value is calculated again in the course of re-execution (retry) when the download of the object is failed. In this case, the processing time becomes even longer.

### SUMMARY

The present disclosure has been made in view of the above-mentioned background. An object of the present disclosure is to provide an information processing system, an information processing method, and a storage medium storing a program being capable of efficiently and promptly downloading and restoring data, which is managed as an object in an object storage, in an apparatus that uses the data.

To attain the object, an aspect of the present disclosure provides an information processing system comprising: an information processing apparatus configured to manage data by using an object storage, wherein in a case of downloading to the information processing apparatus a group of objects used to restore the data to the information processing apparatus, the information processing system is configured to download each of the group of objects to the information processing apparatus through a communication network while subjecting each object to identity verification, to store information to specify the object regarding the object that fails in the identity verification, and to perform re-execution of download targeting at the object failed in the identity verification to the information processing apparatus while subjecting the object to the identity verification.

Other problems and solutions thereof disclosed in the present application will be clarified in the chapter of detailed description of the disclosure and the accompanying drawings.

According to the present disclosure, it is possible to efficiently and promptly download and restore data, which is managed as an object in an object storage, in an apparatus that uses the data.

### BRIEF DESCRIPTION OF THE DRAWINGS

FIG. 1 is a diagram showing an example of an information processing system.

FIG. 2 is a diagram showing an example of functions provided to an NAS apparatus.

FIG. 3 is a block diagram showing an example of a hardware configuration of an information processing apparatus used for realizing the NAS apparatus or a client apparatus.

FIG. 4 is a UML sequence diagram that explains an example of restoration processing.

FIG. 5A is a diagram showing an example of an object.

FIG. 5B is a table showing an example of contents described in metadata.

FIG. 6A is an example of a restoration target object list.

FIG. 6B is an example of a restored object list.

FIG. 7A is a flowchart that explains an example of restoration processing (first time).

FIG. 7B is a flowchart that explains an example of root directory restoration processing (first time).

FIG. 8 is a flowchart that explains an example of restoration processing (re-execution).

FIG. 9 is a flowchart that explains an example of lower layer restoration processing (re-execution).

FIG. 10 is a diagram showing another configuration example of the NAS apparatus.

FIG. 11 is a diagram showing an example of a restoration processing progress presentation screen.

FIG. 12 is a diagram showing an example of processing to be carried out when restoring an object in an NAS apparatus through a communication network.

### DETAILED DESCRIPTION OF EMBODIMENTS

An embodiment of the present disclosure will be described below with reference to the drawings as appropriate. The following description and drawings form an example for explaining the present disclosure and are therefore abridged and simplified as appropriate in order to clarify the description. The present disclosure can also be embodied in various other modes. Respective constituents discussed herein may be either singular or plural unless otherwise specified.

In the following description, identical or similar constituents may be denoted by the same reference signs and overlapping explanations may be omitted as appropriate. Moreover, in the following description, a letter “S” prefixed to a code represents a “step of processing”. Meanwhile, a variety of information may be described in the following description by using expressions including “information”, a “list”, a “queue”, and so forth as appropriate. However, such a variety of information may be expressed by using other data structures than the aforementioned structures. In addition, in the following description, a “network” may be abbreviated as “NW” when appropriate.

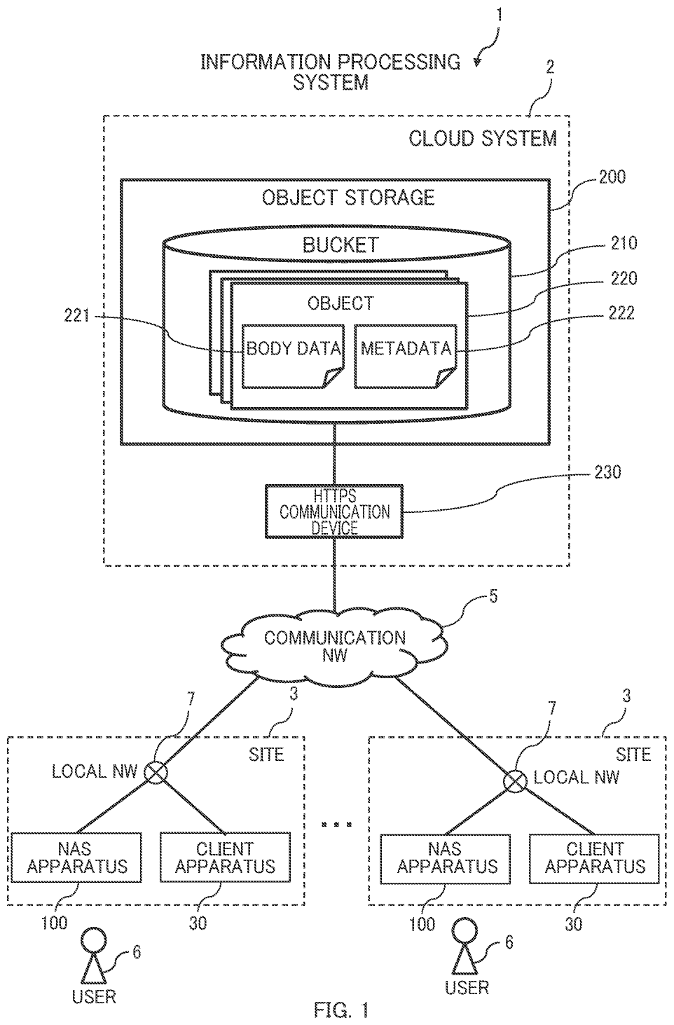

FIG. 1 shows a schematic configuration of an information processing system 1 described as an embodiment. As shown in FIG. 1, the information processing system 1 includes an object storage 200 provided by a cloud system 2, and NAS apparatuses 100 installed in respective sites 3 that use the object storage 200 for the purpose of data backup and the like.

An HTTPS communication device 230 of the cloud system 2 is communicably coupled to a local NW 7 of each site 3 through a communication NW 5. The object storage 200 communicates with the NAS apparatus 100 at each site 3 through the HTTPS communication device 230, the communication NW 5, and the local NW 7.

The communication NW 5 is any of the Internet, a wide area network (WAN), and a local area network (LAN), for example. The communication NW 5 is realized by a communication infrastructure adopting any of various public radio communication networks, dedicated lines, and the like.

At each site 3, the NAS apparatus 100 is communicably coupled through the local NW 7 to at least one client apparatus 30 that uses services of the NAS apparatus 100. For example, the NAS apparatus 100 provides the client apparatus 30 coupled thereto with services (network file system (NFS)/common Internet file system (CIFS) service and the like) of a file server.

The object storage 200 manages one or more objects 220 in a space (a data storage area) which is referred to as a bucket 210 (which may also be referred to as a “container”). Two or more buckets 210 may be provided in some cases. Each object 220 includes a piece of body data 221 and a piece of metadata 222, for example.

The HTTPS communication device 230 carries out communication in accordance with hypertext transfer protocol secure (HTTPS) with the NAS apparatus 100 at each site 3 through the communication NW 5. When the HTTPS communication device 230 receives, for example, a download request sent from the NAS apparatus 100, the HTTPS communication device 230 forwards the download request to the object storage 200. Meanwhile, the HTTPS communication device 230 relays data transfer from the object storage 200 to the NAS apparatus 100 (such as transfer of data to be downloaded to the NAS apparatus 100).

The NAS apparatus 100 uses the object storage 200 as a data storage space (a data management area or a data storage area). The NAS apparatus 100 uses, for example, the object storage 200 as a backup site for data of a file system (hereinafter referred to as “file system data”) that the NAS apparatus 100 provides to each client apparatus 30. The NAS apparatus 100 provides a user such as an administrator of the NAS apparatus 100 with a user interface (command line interface (CLI), graphical user interface (GUI), or the like) for performing setting and condition confirmation concerning the object storage 200.

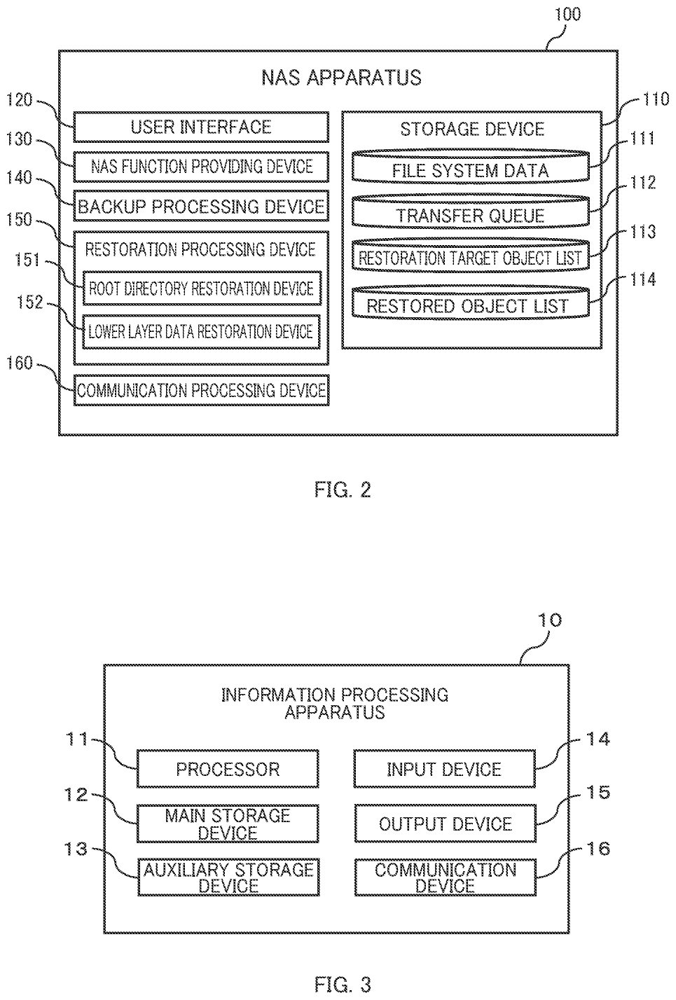

FIG. 2 shows major functions equipped in the NAS apparatus 100. As shown in FIG. 2, the NAS apparatus 100 has functions as a storage device 110, a user interface 120, a NAS function providing device 130, a backup processing device 140, a restoration processing device 150, and a communication processing device 160. Here, the restoration processing device 150 includes functions as a root directory restoration device 151 and a lower layer data restoration device 152.

Among the above-mentioned functions, the storage device 110 stores information (data) on file system data 111, a transfer queue 112, a restoration target object list 113, and a restored object list 114.

Among them, the file system data 111 is the above-mentioned file system data (material data (directory and file data), various management data on the file system, and the like).

An identifier (uniform resource identifier (URI), hereinafter referred to as an “object ID”) of the object 220 that the NAS apparatus 100 attempts to download from the object storage 200 is registered with the transfer queue 112. Queuing of the object ID to and from the transfer queue 112 (registration with and deletion from the transfer queue 112) is carried out in a first-in first-out (FIFO) mode, for example. Though the NAS apparatus 100 also uploads data to the object storage 200, a function concerning the upload is assumed to be realized in accordance with publicly known techniques and a description thereof will be omitted in this embodiment.

The restoration target object list 113 stores a list of object IDs regarding the objects 220 of the data targeted for restoration from the object storage 200. For example, information on the restoration target object list 113 is provided from the object storage 200 through the communication NW 5 as needed.

The restored object list 114 stores a list of object IDs regarding the objects 220 (hereinafter referred to as “restored objects”) which are successfully downloaded from the object storage 200 (or which are successfully restored).

Of the above-described functions, the user interface 120 provides a user 6 with a user interface (CLI, GUI, or the like) for performing control and monitoring of the NAS apparatus 100. All or part of the user interface 120 may be provided by the cloud system 2 in the form of application programming interface (API) or the like, for example. For example, the user interface 120 accepts from the user 6 a backup instruction (or an upload instruction) of the file system data 111 to the object storage 200 or a restoration instruction (or a download instruction (a data restoration instruction)) of the file system data 111 from the object storage 200.

The NAS function providing device 130 provides the client apparatus 30 with various services (provision of a file server, provision of a file sharing environment, file access control, and the like).

The backup processing device 140 carries out processing concerning backup (upload) of the file system data 111 to the object storage 200.

The restoration processing device 150 carries out processing concerning restoration (download, data restoration) of the file system data 111 from the object storage 200. Details of functions of the restoration processing device 150 will be described later. Here, software for realizing the functions of the restoration processing device 150 is constructed by using a software development kit (SDK) provided by the cloud system 2 for using the object storage 200, for example.

The communication processing device 160 carries out processing concerning communication with the object storage 200 or the client apparatus 30 (communication through the communication NW 5 and the local NW 7). The communication processing device 160 carries out the communication with the object storage 200 in accordance with HTTPS.

FIG. 3 is a block diagram showing an example of a hardware configuration of an information processing apparatus used for realizing the NAS apparatus 100 or the client apparatus 30. An information processing apparatus 10 shown as the example includes a processor 11, a main storage device 12 (a memory), an auxiliary storage device 13, an input device 14, an output device 15, and a communication device 16. Examples of the information processing apparatus 10 include a personal computer, an office computer, a server apparatus, a smartphone, a tablet, a general-purpose machine (a mainframe), and the like.

The information processing apparatus 10 may be realized either partially or entirely by using virtual information processing resources provided by employing virtualization technology, process space separation technology, and the like, as represented by a virtual server provided by a cloud system, for example. Meanwhile, all or part of the functions to be provided by the information processing apparatus 10 may be realized by services provided by the cloud system through the API and the like. Alternatively, all or part of the functions to be provided by the information processing apparatus 10 may be realized, for example, by using software as a service (SaaS), platform as a service (PaaS), infrastructure as a service (IaaS), and the like.

For example, the processor 11 is formed by using any of a central processing unit (CPU), a micro processing unit (MPU), a graphics processing unit (GPU), a field programmable gate array (FPGA), an application specific integrated circuit (ASIC), an artificial intelligence (AI) chip, and the like.

The main storage device 12 is a device that stores programs and data, and is any of a read only memory (ROM), a random access memory (RAM), a non-volatile memory (a non-volatile RAM (NVRAM)), and the like. The functions to be realized by the NAS apparatus 100 or the client apparatus 30 are realized by causing the processor 11 to read and execute the programs stored (memorized) in the main storage device 12.

The auxiliary storage device 13 is any of: a solid state drive (SSD); a hard disk drive; an optical storage device (such as a compact disc (CD) and a digital versatile disc (DVD)); a storage system; a reader-writer device for a non-temporary storage medium such as an IC card, an SD card, and an optical storage medium; a non-temporary storage area of a cloud server; and the like. The auxiliary storage device 13 can read programs and data out of another information processing apparatus provided with a non-temporary storage medium and a non-temporary storage device through a storage medium reader device or the communication device 16. The programs and the data stored (memorized) in the auxiliary storage device 13 are loaded into the main storage device 12 as appropriate.

The input device 14 is an interface that accepts input of information from outside, which is any of a keyboard, a mouse, a touch panel, a card reader, a pen input type tablet, and a voice input device, for example.

The output device 15 is an interface that outputs a variety of information such as a progress of processing and a result of processing to the outside. For example, the output device 15 is any of a display device (such as a liquid crystal monitor, a liquid crystal display (LCD), and a graphic card) that visualizes the above-mentioned variety of information, a device (such as a voice output device (like a speaker and the like)) that converts the above-mentioned variety information into voices, and a device (such as a printing device) that converts the above-mentioned variety of information into characters. Here, the information processing apparatus 10 may be configured to input and output information to and from another apparatus through the communication device 16, for example.

The input device 14 and the output device 15 collectively form a user interface that realizes dialogue processing (such as acceptance of the information and provision of the information) with the user.

The communication device 16 is a device that realizes communication with another apparatus. The communication device 16 is a wired or wireless communication interface that realizes communication with such another apparatus in conformity to a prescribed communication protocol through the communication NW 5 and the local NW 7. Examples of the communication device 16 include a network interface card (NIC), a radio communication module, and the like.

For example, an operating system, a file system, a database management system (DBMS) (such as a relational database and NoSQL), a key-value store (KVS), and the like may be introduced to the information processing apparatus 10.

Next, a description will be given of processing to be carried out by the NAS apparatus 100 to restore the file system data 111 from the object storage 200.

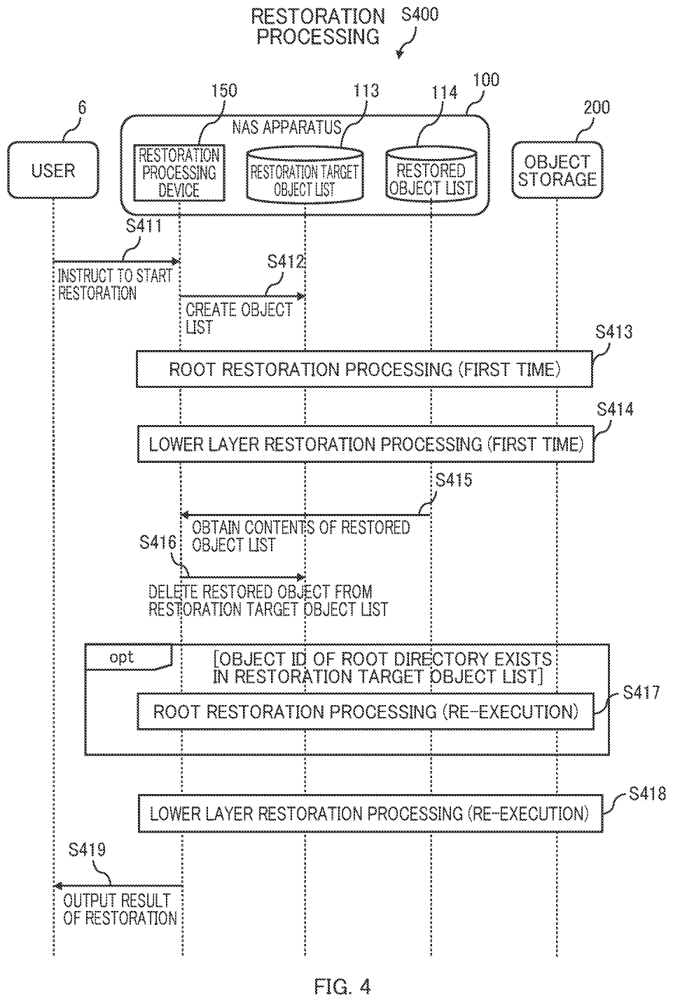

FIG. 4 is a sequence diagram (a unified modeling language (UML) sequence diagram) that explains an outline of processing (hereinafter referred to as “restoration processing S400”) to be carried out by the information processing system 1 when the file system data 111 is restored in the NAS apparatus 100 by using the data backed up as the object 220 in the object storage 200. The restoration processing S400 will be described below with reference to FIG. 4. Here, a group of objects 220 of the file system data 111 backed up in the past are assumed to be stored in object storage 200 at the start of the restoration processing S400. In this embodiment, the object 220 is assumed to be created for each of constituents (directories and files) of the file system data 111 targeted for restoration.

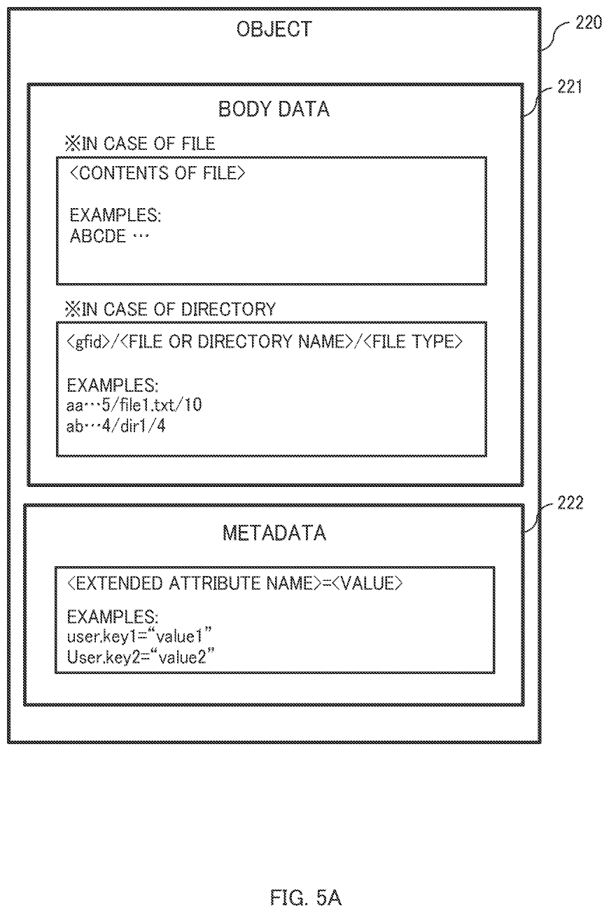

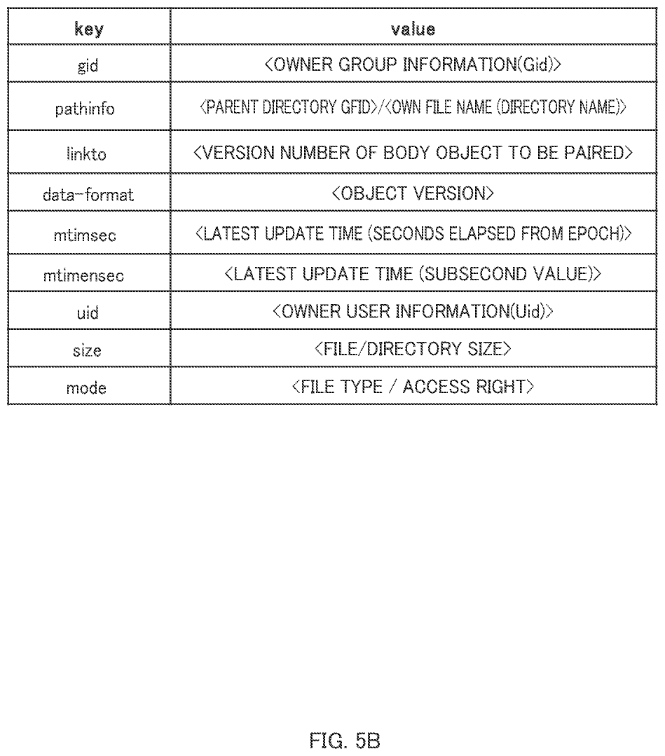

FIG. 5A shows an example of the object 220 (the body data 221 and the metadata 222) stored in the object storage 200. Meanwhile, FIG. 5B shows an example of contents (keys and values) described in the metadata 222. Although not illustrated, information indicating an object ID is attached to each object 220.

As shown in FIG. 4, in a case of restoring the file system data 111, the restoration processing device 150 of the NAS apparatus 100 accepts an instruction to start restoration of the file system data 111 from the user through the user interface 120 (S411). When the start instruction is accepted, the restoration processing device 150 creates the restoration target object list 113 to begin with (S412).

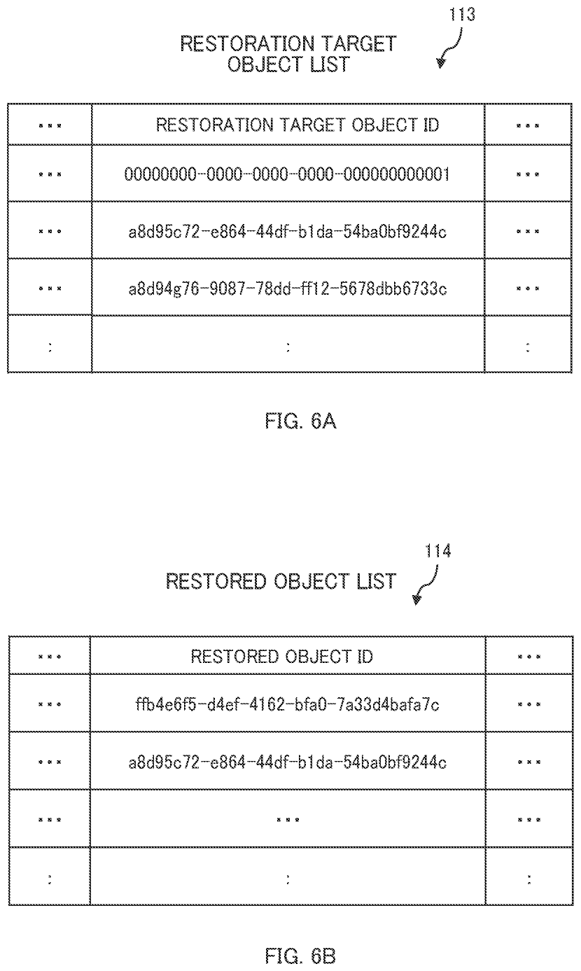

FIG. 6A shows an example of the restoration target object list 113. The restoration target object list 113 shown as the example includes a list of object IDs of the respective objects 220 targeted for restoration (hereinafter referred to as “restoration target object IDs”). Here, the restoration target object list 113 may include other information concerning the objects 220 (such as data sizes of the objects).

Back to FIG. 4, the restoration processing device 150 subsequently carries out processing to restore the data on a root directory out of the file system data 111 of the restoration target (hereinafter referred to as “root restoration processing (first time) S413”). To be more precise, the restoration processing device 150 downloads the object 220 of the root directory from the object storage 200, and restores the data on the root directory as the file system data 111 in a storage area (a storage volume) of the NAS apparatus 100 based on the downloaded object 220. Here, the above-mentioned download is conducted by means of HTTP communication, and the downloaded object 220 is subjected to identity verification (also referred to as “damage check”, “falsification check”, “consistency verification”, and so forth) by using an identity verification function of the HTTPS communication. When the restoration of the root directory in the root restoration processing (first time) S413 is successful, the restoration processing device 150 stores information indicating that the root directory has been restored in the restored object list 114.

Subsequently, the restoration processing device 150 carries out processing to restore directories and files of respective layers lower than the root directory in the file system data 111 of the restoration target (hereinafter referred to as “lower layer restoration processing (first time) S414”). To be more precise, the restoration processing device 150 downloads the respective objects 220 of the directories and the files of the layers lower than the root directory from the object storage 200, and restores the directories and the files of the respective layers lower than the root directory are restored as the file system data 111 in the storage area (the storage volume) of the NAS apparatus 100 based on the respective downloaded objects 220. Here, the above-mentioned download is conducted by means of the HTTP communication, and the downloaded objects 220 are subjected to the identity verification by using the above-mentioned identity verification function of the HTTPS communication. When the restoration of the directories and the files in the lower layer restoration processing (first time) S414 is successful, the restoration processing device 150 stores information indicating that the directories and the files have been restored in the restored object list 114.

FIG. 6B shows an example of the restored object list 114. As shown in FIG. 6B, the restored object list 114 shown as the example includes a list of object IDs of the restored objects 220 (hereinafter referred to as “restored object IDs”). Here, the restored object list 114 may include other information concerning the objects 220 (such as the data sizes of the objects).

Reference is made back to FIG. 4. Next, the restoration processing device 150 obtains the list of the restored object IDs in the restored object list 114 (S415), and deletes (invalidates) the restoration target object IDs which are the same as the obtained restored object IDs from the restoration target object list 113 (S416). As a consequence, the object IDs of the objects 220 failed in restoration will remain as the restoration target objects in the restoration target object list 113.

When there are no objects failed in restoration, or in other words, when the restoration of the entire file system data 111 is completed and the restoration target object list 113 no longer includes any effective restoration target objects 220, the processing goes to S419 where the restoration processing device 150 outputs a restoration completion report, and then the restoration processing is terminated.

On the other hand, the processing goes to S417 when the object ID of the object 220 of the root directory remains in the restoration target object list 113. Meanwhile, the processing goes to S418 when the object ID of the object 220 of the root directory does not remain in the restoration target object list 113 (in other words, when the restoration of the root directory is successful) but the object ID of the object 220 of any of the directories or the files of the layers lower than the root directory remains in the restoration target object list 113 (in other words, when the restoration of the directory or the file of the lower layer is failed).

In S417, the restoration processing device 150 re-executes the restoration of the root directory (this processing will be hereinafter referred to as “root restoration processing (re-execution) S417”). Contents of the root restoration processing (re-execution) S417 are the same as the above-described root restoration processing (first time) S413. After executing the root restoration processing (re-execution) S417, the restoration processing device 150 executes the processing of S418.

In S418, the restoration processing device 150 executes processing to download the object 220 of any of the directories or the files of the layers lower than the root directory (the object corresponding to the object ID remaining in the restoration target object list 113) (this processing will be hereinafter referred to as “lower layer restoration processing (re-execution) S418”).

As a result of the above-described processing, the NAS apparatus 100 outputs information indicating “restoration successful” as a result of restoration when the restoration of the file system data 111 is successful, or outputs information indicating “restoration failed” as the result of restoration when the restoration of the file system data 111 is failed (S419).

As described above, in the information processing system 1 of this embodiment, the verification of identity of the downloaded object is carried out by using the identity verification function of the HTTPS communication in the case of restoring the file system data 111 from the object storage 200 to the NAS apparatus 100. Thus, the file system data 111 can be efficiently and promptly restored in the NAS apparatus 100. Meanwhile, when re-executing (retrying) the download of the object after the failure to restore part of the data, the objects of the data (the directories and the files) that have already been successfully restored are excluded from the download target. Moreover, the verification of identity of the downloaded object is also carried out by using the identity verification function of the HTTPS communication in the case of re-execution. Thus, the data can be efficiently and promptly restored in the case of re-execution as well.

Next, essential parts of the restoration processing S400 shown in FIG. 4 will be sequentially described.

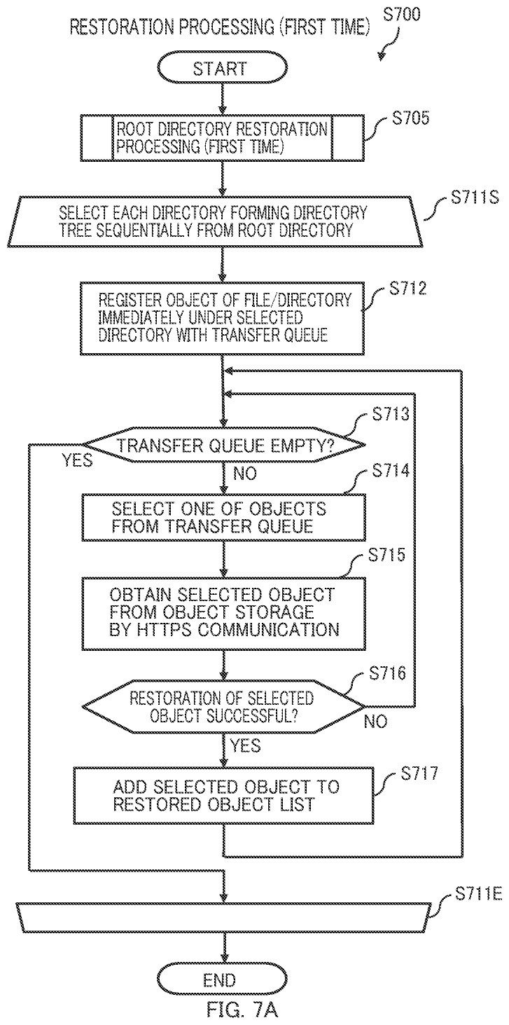

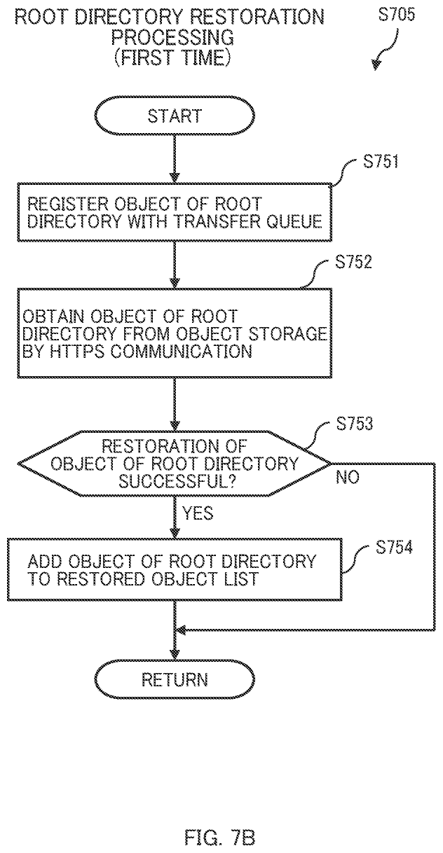

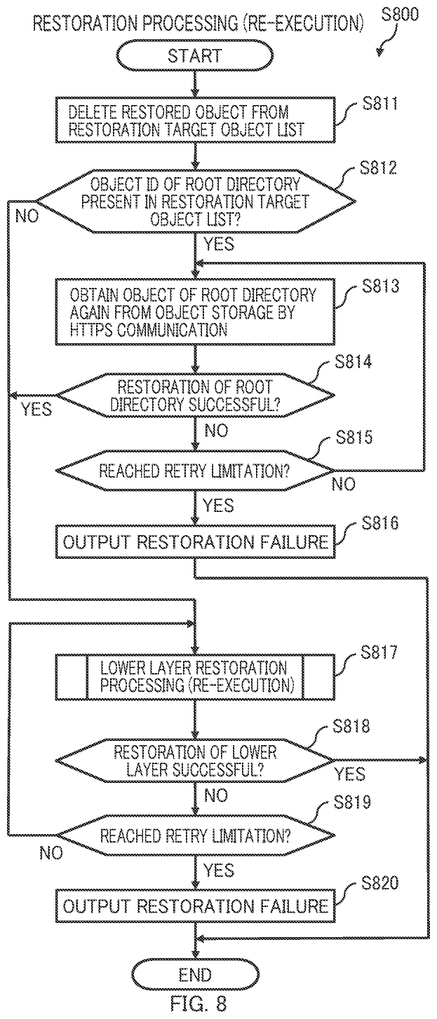

FIG. 7A is a flowchart that explains the root restoration processing (first time) S413 and the lower layer restoration processing (first time) S414 in FIG. 4 (hereinafter collectively referred to as “restoration processing (first time) S700”). The restoration processing (first time) S700 will be described below with reference to FIG. 7A.

First, the restoration processing device 150 attempts processing to obtain the object 220 of the root directory from the object storage 200 (this processing will be hereinafter referred to as “root directory restoration processing (first time) S705”).

FIG. 7B is a flowchart that explains details of the root directory restoration processing (first time) S705. The root directory restoration processing (first time) S705 will be described below with reference to FIG. 7B.

First, the restoration processing device 150 registers the object ID of the object 220 of the root directory with the transfer queue 112 (S751).

Next, the restoration processing device 150 transmits a GET command in accordance with HTTPS to the object storage 200, and obtains (downloads) the object 220 of the root directory from the object storage 200 (S752). In this instance, the downloaded object 220 is subjected to the identity verification in accordance with HTTPS.

Subsequently, the restoration processing device 150 determines whether or not the restoration of the object 220 of the root directory is successful (whether or not the identity verification is successful) (S753). Here, the restoration of the object 220 of the root directory ends in failure when the identity verification is failed. The processing goes to S754 when the restoration processing device 150 determines that the restoration of the selected object 220 is successful (S753: yes). On the other hand, when the restoration processing device 150 determines that the restoration of the selected object 220 is failed (S753: no), the root directory restoration processing (first time) S705 is terminated and the processing goes to S711S in FIG. 7A.

In S754, the restoration processing device 150 adds the object ID of the object 220 of the root directory to the restored object list 114. Thereafter, the root directory restoration processing (first time) S705 is terminated and the processing goes to S711S in FIG. 7A.

The description will be continued with reference back to FIG. 7A. Processing from S711S to S711E shown in FIG. 7A is loop processing to be repeatedly executed for each of sequentially selected directories that form a directory tree of the file system realized by the file system data 111. Here, the restoration processing device 150 is assumed to select the root directory in the loop processing for the first time.

In S712, the restoration processing device 150 registers the object IDs of the objects 220 of the directories and the files existing immediately under the selected directory (the object IDs of all of the objects 220 immediately under the selected directory described in the restoration target object list 113 created in S412) with the transfer queue 112.

Next, the restoration processing device 150 determines whether or not the transfer queue 112 is empty (without registration of any objects 220 (object IDs)) (S713). When the transfer queue 112 is empty (S713: yes), the restoration processing device 150 re-executes the loop processing from S711S to S711E while selecting an unprocessed directory. On the other hand, the processing goes to S714 when the transfer queue 112 is not empty (S713: no).

In S714, the restoration processing device 150 selects one of the objects 220 (the object IDs) from the transfer queue.

Next, the restoration processing device 150 transmits the GET command in accordance with HTTPS to the object storage 200, and obtains (downloads) the selected object 220 from the object storage 200 (S715). In this instance, the downloaded object 220 is subjected to the identity verification in accordance with HTTPS.

Subsequently, the restoration processing device 150 determines whether or not the restoration of the selected object 220 is successful (whether or not the identity verification is successful) (S716). Here, the restoration of the object 220 ends in failure when the identity verification is failed. The processing goes to S717 when the restoration processing device 150 determines that the restoration of the selected object 220 is successful (S716: yes). On the other hand, the processing returns to S713 when the restoration processing device 150 determines that the restoration of the selected object 220 is failed (S716: no).

In S717, the restoration processing device 150 adds the object ID of the selected object 220 to the restored object list 114. Then, the processing returns to S713.

Here, the above-described restoration processing (first time) S700 is a mere example and another algorithm may be adopted as long as that algorithm encompasses all of the directories and the files that form the directory tree. For example, a recursive algorithm may be adopted as the algorithm of repeated processing attributed to an embedded structure (a nested structure) of directories.

FIG. 8 is a flowchart that explains the root restoration processing (re-execution) S417 and the lower layer restoration processing (re-execution) S418 in FIG. 4 (hereinafter collectively referred to as “restoration processing (re-execution) S800”). The restoration processing (re-execution) S800 will be described below with reference to FIG. 8.

First, the restoration processing device 150 deletes (invalidates) the restored object IDs in the restored object list 114 from the restoration target object list 113 (S811).

Next, the restoration processing device 150 determines whether or not there is the object ID of the object 220 of the root directory in the restoration target object list 113 (S812). The processing goes to S813 when the restoration processing device 150 determines that there is the object ID of the object 220 of the root directory in the restoration target object list 113 (S812: yes). The processing goes to S817 when the restoration processing device 150 determines that there is no object ID of the object 220 of the root directory in the restoration target object list 113 (that the root directory has been restored) (S812: no).

In S813, the restoration processing device 150 obtains (downloads) the object 220 of the root directory from the object storage 200. In this instance, the downloaded object 220 is subjected to the identity verification in accordance with HTTPS.

Next, the restoration processing device 150 determines whether or not the restoration of the root directory is successful (S814). Here, the restoration of the object 220 ends in failure when the identity verification is failed. The processing goes to S817 when the restoration processing device 150 determines that the restoration of the root directory is successful (S814: yes). On the other hand, the processing goes to S815 when the restoration processing device 150 determines that the restoration of the root directory is failed (S814: no).

In S815, the restoration processing device 150 determines whether or not the number of times of the attempt to obtain the root directory (hereinafter referred to as the “number of times of retry”) at this point has reached a predetermined limited number of times (hereinafter referred to as a “retry limitation”). When the restoration processing device 150 determines that the number of times of retry has reached the retry limitation (S815: yes), the restoration processing device 150 outputs information indicating the failure in restoration (S816), and terminates the restoration processing (re-execution) S800. On the other hand, the processing returns to S813 when the restoration processing device 150 determines that the number of times of retry has not reached the retry limitation yet (S815: no).

In S817, the restoration processing device 150 executes processing to re-execute (retry) the restoration processing of the directories and the files of the layers lower than the root directory (this processing will be hereinafter referred to as “lower layer restoration processing (re-execution) S817”). Details of the lower layer restoration processing (re-execution) S817 will be described later.

Next, the restoration processing device 150 determines whether or not the restoration of all of the directories and the files of the layers lower than the root directory by the lower layer restoration processing (re-execution) S817 is successful (whether or not the restoration target object list 113 is empty (that no effective object IDs are registered)) (S818). The restoration processing (re-execution) S800 is terminated when the restoration processing device 150 determines that the restoration of all of the directories and the files of the lower layers is successful (S818: yes). On the other hand, the processing goes to S819 when the restoration processing device 150 determines that the restoration of any of the directories and the files of the lower layers is failed (that any of the effective object IDs remains in the restoration target object list 113) (S818: no).

In S819, the restoration processing device 150 determines whether or not the number of times of the attempt to obtain the directories and the files of the lower layers (hereinafter referred to as the “number of times of retry”) at this point has reached a predetermined limited number of times (hereinafter referred to as a “retry limitation”). When the restoration processing device 150 determines that the number of times of retry has reached the retry limitation (S819: yes), the restoration processing device 150 outputs information indicating the failure in restoration (S820), and terminates the restoration processing (re-execution) S800. On the other hand, the processing returns to S817 when the restoration processing device 150 determines that the number of times of retry has not reached the retry limitation yet (S819: no).

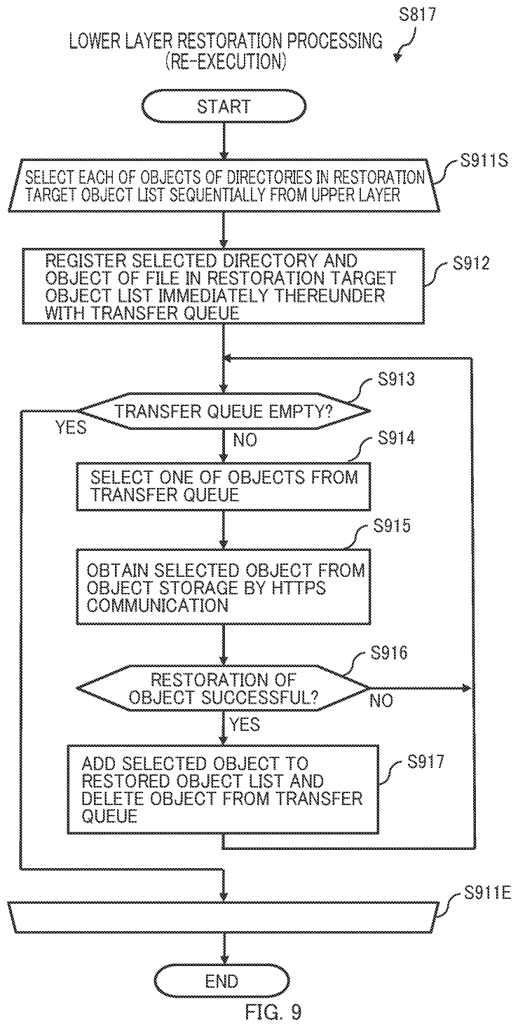

FIG. 9 is a flowchart that explains details of the lower layer restoration processing (re-execution) S817 in FIG. 8. The lower layer restoration processing (re-execution) S817 will be described below with reference to FIG. 9.

Processing from S911S to S911E shown in FIG. 9 is loop processing to be repeatedly executed for each of the objects 220 (the restoration target object IDs) of the directories effectively registered with the restoration target object list 113 and selected one by one from an upper layer by the restoration processing device 150.

In S912, the restoration processing device 150 registers the object ID of the selected directory and the object ID of the file existing immediately under the selected directory that is effectively registered with the restoration target object list 113 with the transfer queue. Here, when the selected directory is the directory immediately under the root directory, the object ID of the file on the same layer as the directory effectively registered with the restoration target object list 113 is also registered with the transfer queue.

Next, the restoration processing device 150 determines whether or not the transfer queue 112 is empty (without registration of any objects IDs) (S913). When the transfer queue 112 is determined to be empty (S913: yes), the restoration processing device 150 re-executes the loop processing from S911S to S911E while selecting an unprocessed directory on the restoration target object list 113. On the other hand, the processing goes to S914 when the transfer queue 112 is not empty (S913: no).

In S914, the restoration processing device 150 selects one of the object IDs from the transfer queue 112.

Next, the restoration processing device 150 obtains (downloads) the object 220 of the selected object ID from the object storage 200 (S915). In this instance, the downloaded object 220 is subjected to the identity verification in accordance with HTTPS.

Subsequently, the restoration processing device 150 determines whether or not the restoration of the object 220 of the selected object ID is successful (S916). Here, the restoration processing device 150 determines that the restoration of the object 220 is successful when the identity verification is successful in S915, or determines that the restoration of the object 220 is failed when the identity verification is failed in S915. The processing goes to S917 when the restoration processing device 150 determines that the restoration of the object 220 is successful (S916: yes). On the other hand, the processing returns to S913 when the restoration processing device 150 determines that the restoration of the object 220 is failed (S916: no).

In S917, the restoration processing device 150 adds the selected object ID to the restored object list 114, and deletes (invalidates) the object ID from the transfer queue 112.

Here, the above-described lower layer restoration processing (re-execution) S817 is a mere example and another algorithm may be adopted as long as that algorithm encompasses all of the files and the directories existing under the root directory. For example, a recursive algorithm may be adopted as the algorithm of repeated processing attributed to the embedded structure (the nested structure) of directories.

Although the embodiment has been described above, the present disclosure is not limited only to the above-described embodiment and encompasses various modified examples. The present disclosure is not necessarily limited to the configuration that includes all of the constituents described above. Meanwhile, it is possible to replace part of a configuration of a certain embodiment with a configuration of another embodiment, and to add such a configuration of another embodiment to the configuration of the certain embodiment. In the meantime, part of a configuration of each embodiment can be subjected to addition, deletion, and replacement of another configuration.

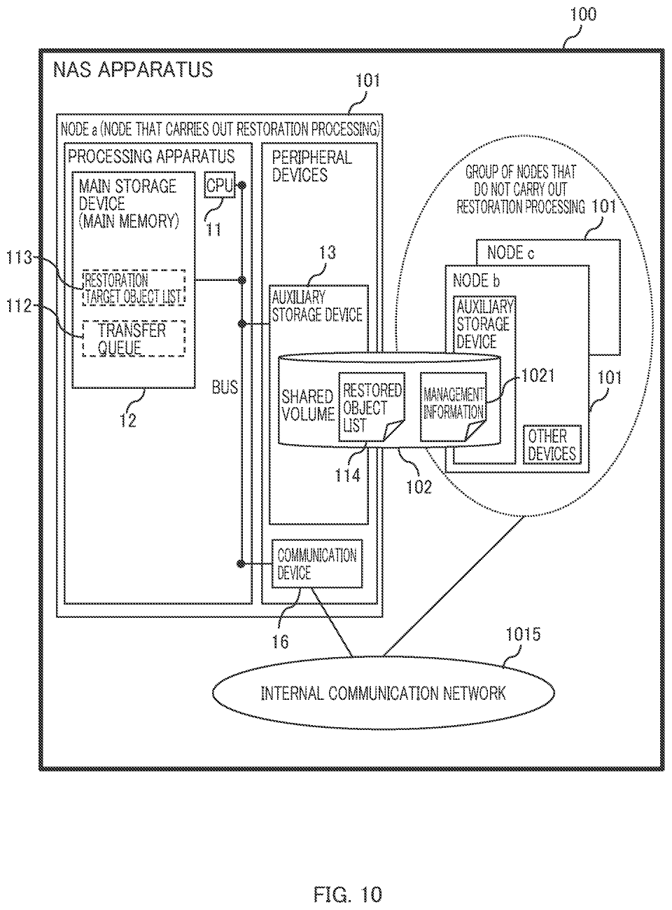

For example, FIG. 10 shows another configuration example of the NAS apparatus 100. The NAS apparatus 100 shown as the example includes multiple nodes 101a to 101c each functioning as the information processing apparatus. Each of the nodes 101a to 101c includes the processor 11, the main storage device 12, the auxiliary storage device 13, and the communication device 16. The communication devices 16 of the nodes 101a to 101c are communicably coupled to one another through an internal communication network 1015. Storage areas provided by the auxiliary storage devices 13 of the respective nodes 101a to 101c form a shared volume 102 and a management volume 103, which are accessible by the nodes 101a to 101c. The file system data 111 of the file system is stored in the shared volume 102. The file system is realized by the respective nodes 101a to 101c and provided to the client apparatus 30. The restored object list 114 and management information 1021 are stored in the management volume 103. Pieces of authentication information used when the NAS apparatus 100 accesses the object storage 200, information indicating a correlation between the object 220 and the file system data 111, and the like are stored in the management information 1021. The programs and the data (the restoration target object list 113, the transfer queue 112, and the like) for realizing the various functions shown in FIG. 2 are stored in the main storage device 12 of the node 101 (which is a “node a” in FIG. 10) that performs backup of the file system data 111 by using the object storage 200.

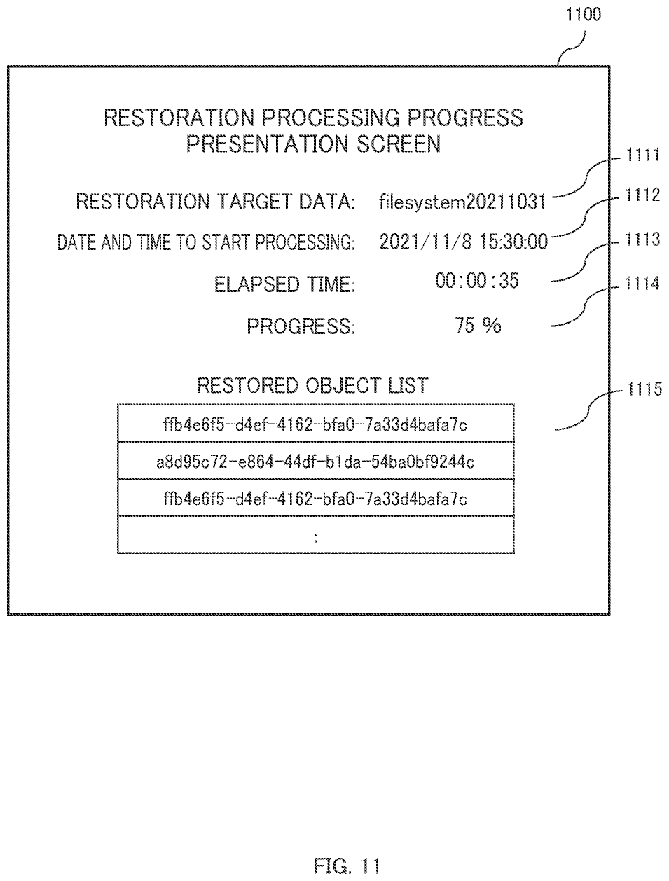

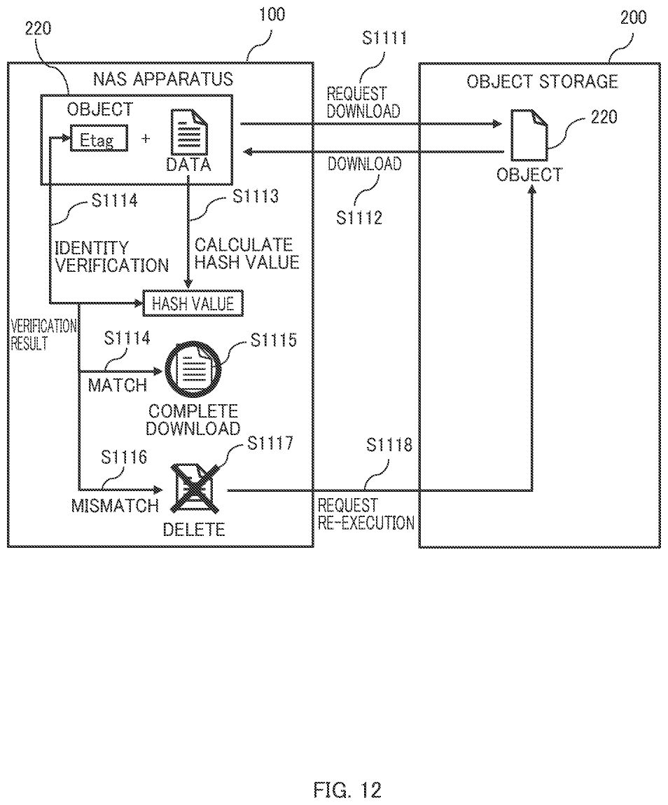

Meanwhile, FIG. 11 shows an example of a screen to be presented to the user 6 by the NAS apparatus 100 (hereinafter referred to as a “restoration processing progress presentation screen 1100”) in the course of executing the restoration processing S400 shown in FIG. 4. Information 1111 indicating the restoration target data, date and time 1112 to start the restoration processing, time 1113 elapsed since the start of the processing, a progress 1114 of the restoration processing, and a list 1115 of the object IDs of the restored objects are displayed on the restoration processing progress presentation screen 1100 shown as the example. Here, the list 1115 of the object IDs is based on the contents of the restored object list 114 shown in FIG. 6B. The user can easily confirm the progress of the restoration processing by referring to the restoration processing progress presentation screen 1100.

What is claimed is:

1. An information processing system comprising:
an information processing apparatus configured to manage data by using an object storage, wherein
in a case of downloading to the information processing apparatus a group of objects used to restore the data to the information processing apparatus, the information processing system is configured
to download each of the group of objects to the information processing apparatus through a communication network while subjecting each object to identity verification,
to store information to specify the object regarding the object that fails in the identity verification, and
to perform re-execution of download targeting at the object failed in the identity verification to the information processing apparatus while subjecting the object to the identity verification.

2. The information processing system according to claim 1, wherein the identity verification is carried out with an identity verification function of a protocol used for communication through the communication network.

3. The information processing system according to claim 2, wherein the protocol is hypertext transfer protocol secure.

4. The information processing system according to claim 1, wherein
the data is data used to form a file system, and
each of the objects corresponds to data on any of a directory and a file that form the file system.

5. The information processing system according to claim 4, wherein the information processing apparatus restores the file system by using the downloaded object.

6. The information processing system according to claim 4, wherein the information processing apparatus is a network attached storage apparatus configured to provide a service of the file system to a different information processing apparatus being communicably coupled.

7. The information processing system according to claim 1, wherein
the information processing system stores
a restoration target object list being a list of the objects used to restore the data, and
a restored object list being a list of the objects successfully subjected to the identity verification, and
in the re-execution, the information processing system performs the download to the information processing apparatus while targeting at the object among the objects described in the restoration target object list except the objects described in the restored object list.

8. The information processing system according to claim 7, wherein
the information processing apparatus includes a plurality of nodes being communicably coupled to one another, each node including a processor, a main storage device, an auxiliary storage device, and a communication device,
the data is stored in a storage area provided by each of the auxiliary storage devices of the nodes,
the restored object list is stored in a storage area provided by the auxiliary storage devices and shared by the respective nodes, and
a group of programs used to operate the object storage and the restoration target object list are stored in the main storage device of at least one of the nodes.

9. An information processing method to be executed by an information processing system including an information processing apparatus configured to manage data by using an object storage, in a case of downloading to the information processing apparatus a group of objects used to restore the data to the information processing apparatus, the information processing method comprising:
causing the information processing system to download each of the group of objects to the information processing apparatus through a communication network while subjecting each object to identity verification;
causing the information processing system to store information to specify the object regarding the object that fails in the identity verification; and
causing the information processing system to perform re-execution of download targeting at the object failed in the identity verification to the information processing apparatus while subjecting the object to the identity verification.

10. A storage medium storing a program to be executed by an information processing system including an information processing apparatus configured to manage data by using an object storage, the storage medium storing a program to be executed by the information processing system to implement:
a function to download each of a group of objects, to be used to restore the data in the information processing apparatus, to the information processing apparatus through a communication network while subjecting each object to identity verification;
a function to store information to specify the object regarding the object that fails in the identity verification; and
a function to perform re-execution of download targeting at the object failed in the identity verification to the information processing apparatus while subjecting the object to the identity verification.
